(19) United States
(12) Patent Application Publication
(10) Pub. No.: US 2015/0073842 A1
(43) Pub. Date: Mar. 12, 2015

(54) Seat Reassignment Method for Transport Vehicles

(71) Applicant: Abdullah Aljabarti, Jeddah (SA)

(72) Inventor: Abdullah Aljabarti, Jeddah (SA)

(21) Appl. No.: 14/480,476

(22) Filed: Sep. 8, 2014

Related U.S. Application Data
(60) Provisional application No. 61/875,281, filed on Sep. 9, 2013.

(51) Int. Cl. G06Q 10/02; B64F 1/36

(52) U.S. Cl. CPC G06Q 10/02; B64F 1/36
USPC 705/5

(57) ABSTRACT

A passenger reassignment method is provided, in which a substantially automated system is employed to reassign passenger seat assignments from one transport vehicle to another without requiring staff to manually reassign seats, distribute updated boarding passes, or permit free-boarding on the new vehicle. In the commercial airline scenario, when one aircraft is downed because of a maintenance issue, the present method analyzes passenger data from the original flight, locates available substitute flights to the same location or general direction, reassigns the original passenger list to the new aircraft or several aircraft, and displays the updated boarding information on a common display or via individualized displays within the aircraft. The method reassigns seats despite desperate interior arrangements or aircraft types between original and substitute aircraft, and optimizes seat usage on alternative flights to maximize seat usage. Overall, the system improves efficiency in the event of a downed aircraft and vehicle substitution.

### CROSS REFERENCE TO RELATED APPLICATION

This application claims the benefit of U.S. Provisional Application No. 61/875,281 filed on Sep. 9, 2013. The above identified patent application is herein incorporated by reference in its entirety to provide continuity of disclosure.

### BACKGROUND OF THE INVENTION

1. Field of the Invention

The present invention relates to transport seating and methods of rearranging seating assignments for passengers when switching from one transport to another. More specifically, the present invention comprises a computerized tool and method for automatically reassigning seats to passengers of a transport when the passengers are forced to de-board one transport and board another transport, wherein the second transport may or may not share the same seating configuration.

In many modes of mass transit, occupants are given specific seat assignments within the transport vehicle. This is particularly common in the airlines industry, where long flight times make certain seats more coveted than others for comfort, space and amenities. Generally, each passenger is assigned a seat within a specific zone in the plane, include a seat and row number within one of the several zones provided onboard. Common zones include first class, business class, and coach, wherein the seating configuration of each zone varies along with the price of the seat.

While this method of seating generally improves efficiency with which passengers can be allowed onboard, and furthermore reduces long lines prior to boarding, problems occur when a schedule flight is cancelled or significantly delayed because of maintenance issues. Down aircraft can lead the airline company to assign a new aircraft to the flight or to distribute the passengers on several subsequent flights. Each of the passengers, having already paid for and received a boarding pass for a specific seat on one plane, may not be able to transfer the same boarding pass to the new aircraft. This is particularly true if the replacement flight is a different fleet of aircraft (different aircraft type), has some seats already occupied, or the interior configuration of the replacement aircraft does not exactly match the first aircraft.

Generally the airlines in this situation will allow free boarding onto the new aircraft. In other instances, the airlines will print out separate boarding passes may be distributed prior to boarding the new aircraft. However, both of these alternatives have significant drawbacks. Free boarding tends to lead to chaos upon boarding, and makes desired seats a free for all. Those who prepaid for specific seats or zones may not be given what they were promised, and overall the process will be inefficient. Likewise, printing and distributing new boarding passes to each passenger requires the airlines personnel to personally match each passenger with a new seat, print each boarding pass and then distribute the same before re-collecting the passes upon boarding. This is extremely inefficient and causes significant delays.

To address this known issue in the art, the present invention contemplates a system that automates the reassignment of passengers when transferring a plane-load of passengers from one aircraft to another. The system can take into account several data sources, compile the data, reassign seats in the most efficient manner practicable, and then allow passengers to board without re-printing boarding passes or allowing open seating. Specifically, the system recognizes the aircraft type and interior configuration, finds replacement flights that are headed to the same or substantially the same destination, compares the seating arrangements and openings, reassigns seats for each passenger, and then visually displays the seat position on the new plane. The visualization step may occur on a common display upon boarding, or alternatively individual displays above each row can indicate the prior seat number from the first aircraft in a position on the new aircraft. Efficiency is improved with respect to boarding and downtime is minimized. Furthermore, space on potentially empty flights can be filled to maximize cost savings for the airlines in instances when one flight is downed and others can be used in its stead.

2. Description of the Prior Art

Devices have been disclosed in the prior art that relate to transport seating and transport interior arraignments. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

One such device in the prior art is U.S. Patent Publication No. 2010/0318385 to Serra, which discloses a method for assigning seats on board an aircraft or like means of transport, wherein the personalities and interests of the passengers are taken into account to seat like-minded individuals near one another. Demographic and personal information about the passengers is compiled such that seats on board the transport are assigned according to compatibility of the occupants. The Serra method, while providing an interesting option for travelers, fails to contemplate seat reassignment procedures when one means of transport is replaced by another prior to a trip because of mechanical issues.

The present invention contemplates a system and method that can compile seating information from one transport and reassign occupants in another available transport, independent of complete availability, type of transport vehicle, or seating arrangement. The present invention is an efficiency tool directed at the airlines industry when mechanical failures cause grounded planes, and methods of improving re-boarding procedures to reduce delays.

U.S. Patent Publication No. 2005/0002198 to Blechschmidt discloses a system for improving a passenger's ability to find their assigned seating section on a plane using specific interior lighting and the boarding pass. Specifically colored lighting within the cabin of the plane is used for each cabin section. The boarding passes are provided with corresponding numbers according to the cabin zoned the passenger has been assigned. This facilitates boarding.

The Blechschmidt, similar to the Serra method, both relate to boarding and to arranging seating within a transport vehicle. However, these devices are not suited for rearranging seating assignments when moving all passengers from one vehicle to another and providing new seating assignments if necessary to each passenger without printing new boarding passes. The present invention improves upon current methods, which include printing new boarding passes or allowing open seating to passengers, whereby ordered and efficient seating on the new plane is provided using a system that compares the two flights and reassigns the seat locations. The output of the present invention is not limited to new boarding passes, but can be provided in the form of a singular display that visually updates passengers of their new seat, or individualized seating markers in the plane that direct passengers in the plane using their originally assigned seating number.

Overall, the present invention improves efficiency and reduces downtime when an aircraft is deemed unavailable and passengers must be moved from the downed aircraft to a substitute aircraft. The system is substantially automated, with inputs available to airlines personnel for specific instances. It is submitted that the present invention substantially diverges in design elements from the prior art, and consequently it is clear that there is a need in the art for an improvement to existing transport reseating methods. In this regard the instant invention substantially fulfills these needs.

### SUMMARY OF THE INVENTION

In view of the foregoing disadvantages inherent in the known types of passenger assignment and reassignment methods now present in the prior art, the present invention provides a new method in which passengers of transit vehicles can be reassigned a seat location in the event the transport vehicle is not available and a replacement vehicle is necessary.

It is therefore an object of the present invention to provide a new and improved seat reassignment system and method that has all of the advantages of the prior art and none of the disadvantages.

It is another object of the present invention to provide a method of reassigning seats to passengers when there is a need to transfer between transport vehicles and seating arrangements are not the same between vehicles.

Another object of the present invention is to provide a method of reassigning seats to passengers that does not require user input to calculate seat reassignments and place each passenger in a new seat, while offering some input from users if tailoring of the assignments is desired.

Yet another object of the present invention is to provide method of reassigning seats to passengers that is particularly suited for the airline industry, in which seating assignment is commonplace and downed aircraft represent a significant burden on efficiency, cost, and timeliness of the airline.

Another object of the present invention is to provide method of reassigning seats to passengers that is particularly suited for the airline industry, in which aircraft of different type having varying seating arrangements, and further still aircraft of the same type sometimes have different interior arrangements.

Another object of the present invention is to provide method of reassigning seats that does not require boarding passes, but rather provides a visual display or series of displays to indicate where a passenger must relocate within the next vehicle.

Another object of the present invention is to provide method of reassigning seats that is carried out by a computer system that draws information from various sources, including data from various sever-stored databases related to aircraft seating arrangement, passenger information, active flight information, and the like.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a view of the data sources used to calculate seat reassignments by the present method.

FIG. 2 shows a flow diagram outlining steps of the method.

FIG. 3 shows a view illustrative of one embodiment of the visual display for passenger re-boarding.

### DETAILED DESCRIPTION OF THE INVENTION

Reference is made herein to the attached drawings. Like reference numerals are used throughout the drawings to depict like or similar elements of the seat reassignment method of the present invention. For the purposes of presenting a brief and clear description of the present invention, the preferred embodiment will be discussed as used for facilitating seat reassignment in a passenger aircraft when one aircraft is supplemented for another in the event of a mechanical condition that grounds the first flight. The figures are intended for representative purposes only and should not be considered to be limiting in any respect.

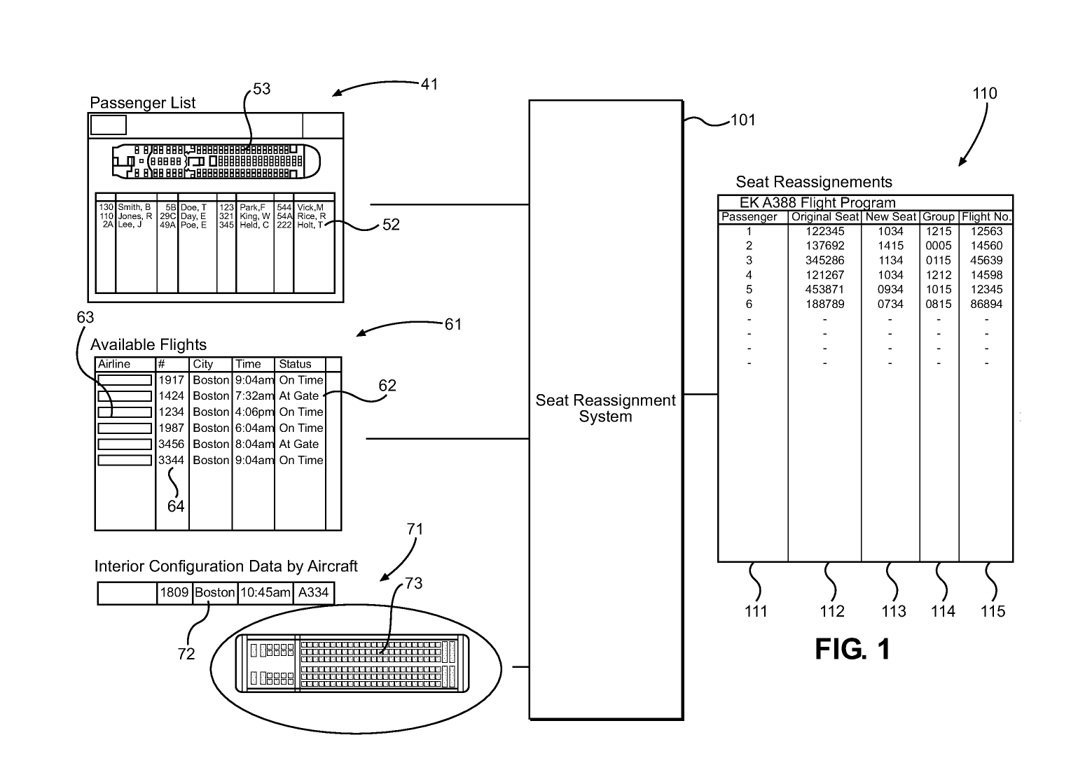

Referring now to FIG. 1, there is shown a view of the data sources used by the present invention for the purposes of analyzing a current aircraft and then reassigning all passengers on the aircraft to a substitute aircraft or several alternative flights. The present invention comprises a method of reassigning seats to passengers in the event that their transport vehicle becomes unavailable prior to or during a trip and substitute transport is required. The method in which this is handled currently leads to great inefficiencies and lost time for the transport company. This is particularly true in air travel and in the commercial airline industry, where lost time during the boarding process and grounding delays can cause significant problems. These problems are not just limited to the specific flight, but have a domino effect to other flights and flight arraignments in other airports. Connecting flights may be missed and scheduled timing of flights may be altered at the destination airport, thus causing traffic issues and significant time delays for passengers. All of this contributes to lost revenue and unhappy customers.

To address this known issue in the art, the present invention contemplates a method that is carried out by a computer system, wherein data from the transport company (i.e. the airlines), the airport, and the traveling passengers is used to calculate seat reassignments when one vehicle (i.e. one aircraft) is substituted for another or when passengers are redistributed across several other available flights with space onboard. The present invention is a substantially automated system with limited user inputs, which enables seat reassignments to be calculated without the user having to review passenger lists, view available flights, or check seating arrangements across different aircraft or fleets. The present invention is related to a system that reassigns seats without user input, unless specific accommodations or requests for change are made by users to accommodate specific passengers. It is desired to remove the human element from the seat recalculation process and to automate the process, whereby the time required is reduced to seconds, as opposed to a pure human activity that involves comparing such a large data set and preparing updated seats in a time sensitive environment. The present invention is not desired to replace airlines personnel for singular seat changes, but to provide a tool that can reassign whole flights across different aircraft and across different fleets of aircraft in a rapid, automated process.

Referring specifically to FIG. 1, there present method utilizes a computer system 101 that is connected to a network and in communication with various databases and data servers used by the airline, the airport, and by various Federal agencies that may require input into the system. Generally the present invention is employed just prior to boarding a first aircraft, or just subsequently thereafter when passengers are informed of a maintenance issue that will require the passengers to de-board and be reassigned to an alternative aircraft. In either of these events, each passenger's boarding pass for the original aircraft if likely invalid for the replacement aircraft, as the interior configuration of the aircraft may be different, the type of aircraft used as a replacement may not be the same as the original, or the passengers may be separated into several alternative flights that may have available space to accommodate them.

The method entails querying various data sources related to the flight, the airport, the airlines, and the passengers. The passenger list 51 for the original flight is analyzed, wherein the number of passengers, their identities 52, their original seat assignments 53, and their zones/accommodates are noted. This data is related to the individual passengers of identification purposes and for passenger tracking when original seating locations are reassigned and displayed to the passengers. The goal of the present invention is not to reprint and distributed updated boarding passes, therefore original seat assignments and passenger names are retrieved and stored.

Once the passenger list data 51 is queried and received from an external server and external database, flight lists 61 for the airline and across the airport are searched. External servers and databases are queried to find available substitute aircraft to replace the original flight. The system first searches available aircraft within the same airline that are not assigned to a flight and are on reserve. If unavailable, alternative flights are searched. These include aircraft that are inbound but are scheduled to be idle after the flight, alternative flights that have available space onboard prior to their departure, and available planes that can be diverted to the airport to substitute for the original flight. The method queries all flights, airlines aircraft, and all alternative aircraft sources that may be available that may be used to transport passengers to the original destination 72, or alternatively to a larger hub destination in which connecting flights can be found to the original destination.

In most instances, if the data reveals a substitute aircraft that can depart with the entire original passenger list, its interior configuration or aircraft type may not be the same as the original aircraft. The method of present invention analyzes available seats on the replacement aircraft against those in the original, and the seating configuration 73 of each aircraft and provides updated seating assignments for each passenger. The algorithm employed attempts to match the original zones (i.e. first class, business class, coach, etc.) across the two flights and provide the same seat type, albeit potentially in a different row or position in the row. If the replacement aircraft is too small, the method searches alternative flights to determine which alternative flights can be used to reassign passengers of the original flight. Those passengers left as a remainder are redistributed across different flights using available seat openings, or are alerted that they will not able to be accommodated until another flight becomes available.

The output of the method includes seat reassignment data 110, whereby each passenger, identified by name 111 and/or original seat location 112, is reassigned to a replacement flight 115. Seat assignments 113 are given for each passenger in the replacement flight, as well as a zone or group 114. Therefore, passengers are given the flight number, new seat assignment, and gate information so they can gather their belongings and find the replacement flight in the airport. The seat reassignment data is presented on a common display, and/or within the reassigned aircraft using individual seat displays along the aircraft interior that correlates the original seat assignment with the seat reassignment.

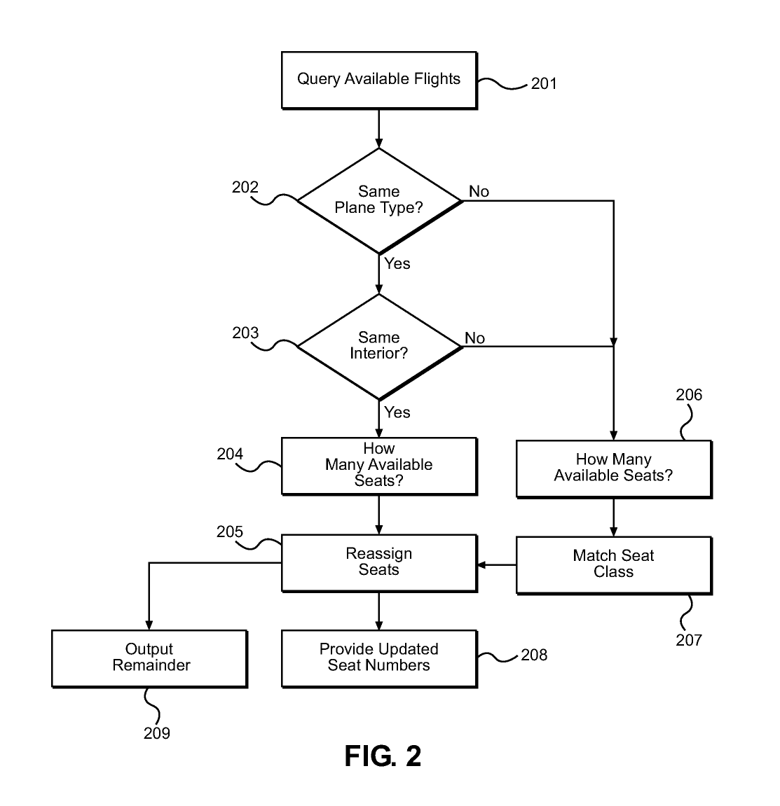

Referring now to FIG. 2, there is shown a flow diagram of the steps of the present invention, in which seat reassignment data is generated from external flight, aircraft and passenger data. First, real-time data for available flights, replacement aircraft, incoming aircraft, and passenger flight data is queried 201 from external servers and compiled into a database. A replacement aircraft is identified that is traveling in the same direction or to the same destination as the original flights and its appropriateness relative to the size and arraignment relative to the original flight is analyzed. The algorithm verifies whether or not the replacement aircraft is the same plane type 202 (i.e. a Boeing 777, Airbus A320, etc.), and then analyzes the interior configuration 203 of that particular aircraft to find out if it shares the same interior configuration as the original flight.

If the plane is not the same type 202 or like interiors are not found 203, the number of available seats 206 on the replacement aircraft is analyzed. The zones or seat types 207 are also analyzed to see if the aircraft has the same number of premium seats as the original flight. If the number of seats is not equal between flights 206, a remainder number of passengers may be found that cannot be reassigned 209. The system will reanalyze different available aircraft to determine if these remainder passengers 209 can be placed on different flights, or if the algorithm needs to restart to find a larger available flight. This optimization finds available space on alternative flights, or tries to fit all passengers from the original flight into the replacement flight. Once the best solution is found, seat reassignments 205 are assigned and posted visually to passengers 208 to find their flight and their updated seat location.

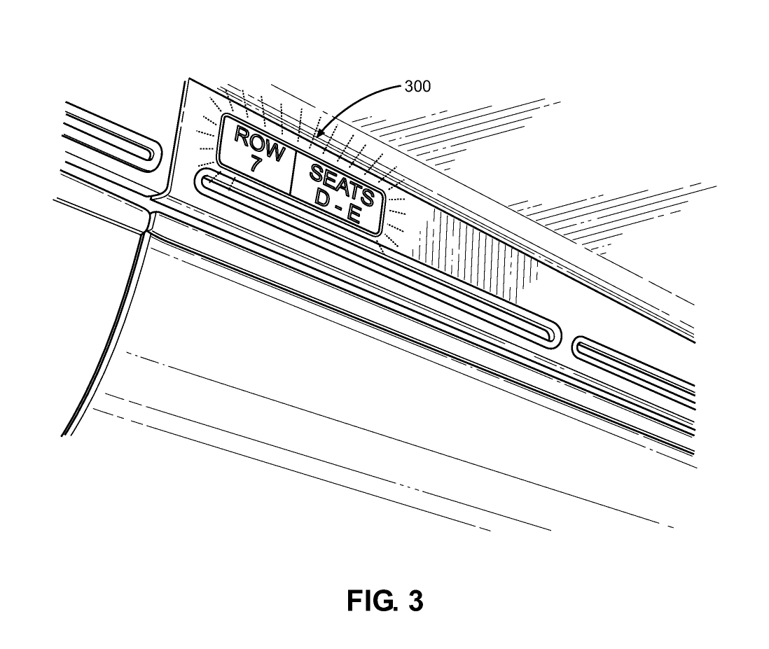

Once seat reassignment data has been generated, the passengers are shown their updated flight and seat assignments without printing new boarding passes. This is accomplished using a common display, in which passenger name, original seat, updated flight number, gate, and updated seat assignment are shown. Furthermore, and as shown in FIG. 3, the interior of the aircraft may be fitted with a display 300 along the interior thereof that can illuminate the original seat location in the part of the aircraft that corresponds to the reassigned seat location. In this embodiment, the original seat is shown adjacent to the updated row and seat number, which allows a user to utilize his or her original boarding pass and locate their seat.

Airline carriers are frequently forced to swap aircrafts with different seating configurations due to technical difficulties, maintenance control, or operational determinations. Unfortunately, this decision is typically made before takeoff after passengers' tickets with their seating assignments have been printed. In these cases, some carriers may allow passengers to choose their seat, but this can anger passengers and can significantly prolong the boarding process. The present invention allows seat reassignments to be rapid and easy for both airlines personnel and for passengers, wherein efficiency is improved and downtime is minimized when switching aircraft. Furthermore, it is contemplated that the present invention may be deployed in different transport environments in which dedicated or assigned seating is provided, including bus transportation, trains transportation, cruise line transportation and the like.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum steps, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A seat reassignment method employing a computer system connected to a network for reassigning passenger seat locations from one transport vehicle to another when a switch of vehicles is required, comprising the steps of:
querying a server and compiling data including passenger information and seat assignment for an original vehicle using a computer system;
querying a server and compiling data of replacement vehicles using said computer system, including vehicle type, seating configuration, seating capacity, availability, and destination of said replacement vehicles;
analyzing queried data using an algorithm on said computer system to automatically determine whether all passengers of said original vehicle can be placed on a first replacement vehicle;
further determining using said algorithm if there is a remainder of passengers if all passengers of said original vehicle are reassigned to said first replacement vehicle;
further determining using said algorithm if additional replacement vehicles are available for said remainder;
computationally optimizing seat capacity of all vehicles by reassigning all passengers to said first replacement vehicle and said alternative vehicle;
digitally displaying seat reassignment data to said passengers on a display without printing said seat reassignment data.

2. The method of claim 2, wherein said transport vehicle and replacement vehicles are aircraft.

3. The method of claim 2, wherein said display is a digital display showing said seat reassignment data shown on a common screen.

4. The method of claim 2, wherein said display is a digital display in said vehicle and above said seats that shows said seat reassignment data on individual screens.
